(19) United States
(12) Patent Application Publication
(10) Pub. No.: US 2006/0203612 A1
(43) Pub. Date: Sep. 14, 2006

(54) Sonde System Including Rotationally and Vertically Offset Tools

(75) Inventors: George R. Kear, Slidell, LA (US); Anish Kumar, River Ridge, LA (US); Brian Briscoe, Marrero, LA (US); Tom Teipner, Mandeville, LA (US)

Correspondence Address: SCHLUMBERGER OILFIELD SERVICES, 200 GILLINGHAM LANE, MD 200-9, SUGAR LAND, TX, 77478, US

(73) Assignee: SCHLUMBERGER TECHNOLOGY CORPORATION, Sugar Land, TX (US)

(21) Appl. No.: 11/420,381

(22) Filed: May 25, 2006

Related U.S. Application Data
(63) Continuation-in-part of application No. 10/248,338, filed on Jan. 10, 2003.

(51) Int. Cl. G01V 1/00

(52) U.S. Cl. 367/25

(57) ABSTRACT

A system for subsurface measurements in a wellbore, with a first tool including a first plurality of pads to be positioned against a surface of the wellbore, each of the pads having a first plurality of electrodes disposed thereon to emit and receive electric alternating current between the electrodes and a second plurality of electrodes disposed thereon between the first plurality of electrodes to measure an electromagnetic parameter. Also including a second tool including a second plurality of pads to be positioned against a surface of the wellbore, each of the pads having a first plurality of electrodes disposed thereon to emit and receive electric alternating current between the electrodes and a second plurality of electrodes disposed thereon between the first plurality of electrodes to measure an electromagnetic parameter. The second tool is longitudinally offset from the first tool and the second plurality of pads of the second tool are rotationally offset relative to the first plurality of pads of the first tool.

### CROSS-REFERENCE TO RELATED APPLICATIONS

This application is a continuation-in-part of U.S. patent application Ser. No. 10/248,338, filed Jan. 10, 2003.

### BACKGROUND OF THE INVENTION

The subject matter of the present invention relates to a dual oil-base mud imaging (OBM) sonde adapted to be disposed in a wellbore, and, more particularly, to two OBMI sondes used in combination and joined together by an adapter, the second OBMI sonde having sensors (also referred to as electrodes herein) which are offset azimuthally by a predetermined angle relative to the sensore of the first OMBI sonde. As a result, the second OBMI sonde will survey areas of the wellbore which are not being surveyed by the first OBMI sonde.

It has always been a challenge for Petroleum Geologists worldwide to find a means to examine and understand the geological characteristics of subsurface lithologic formations. Technological advances in the petroleum industry have made it possible to acquire measurements of the physical properties of subsurface rocks, including micro-resistivity measurements which can be processed into electrical images. A problem area has been wells drilled using oil-based mud (OBM) and synthetic-based mud (SBM) systems. Wells are drilled using OBM and SBM systems in order to minimize any economic risks and maximize drilling efficiency. These mud systems are extremely resistive. Conventional borehole imaging sensor-arrays cannot acquire images in these non-conductive fluids. To make possible borehole resistivity image acquisition in these non-conductive fluids, specialized sensors have been developed to obtain high-resolution images of the borehole. Just as image data from conventional imaging devices can be used in studies for structural and stratigraphic interpretation, including thin-bed detection, compartmentalization, high-resolution net-pay calculation, well correlation, etc., so can image data from OBM and SBM systems. However, there is a limitation in the circumferential coverage of the borehole using these specialized tools. That is, with respect to the borehole circumferential coverage limitation, due to physical problems in the well during image acquisition, there are intervals in the image where the image is highly distorted due to the tool-string getting stuck in the well and subsequently pulling free, or due to poor hole conditions, or drilling mud anisotrophy, or even merely electrical noise. The aforementioned circumferential coverage of the borehole can be greatly increased and the above referenced problems can be corrected by connecting one or more additional imaging tools to a first imaging tool in the tool string, the additional imaging tools having a fixed preset rotational offset and a significant vertical offset with respect to the first imaging tool in the tool string.

### SUMMARY OF THE INVENTION

One aspect of the invention provides a system for subsurface measurements in a wellbore. The system includes a first tool including a first plurality of pads to be positioned against a surface of the wellbore, each of the pads having a first plurality of electrodes disposed thereon to emit electric current between the electrodes and a second plurality of electrodes disposed thereon between the first plurality of electrodes to measure an electromagnetic parameter; a second tool including a second plurality of pads to be positioned against a surface of the wellbore, each of the pads having a first plurality of electrodes disposed thereon to emit electric current between the electrodes and a second plurality of electrodes disposed thereon between the first plurality of electrodes to measure an electromagnetic parameter; the second tool being longitudinally offset from the first tool; and the second plurality of pads of the second tool being rotationally offset relative to the first plurality of pads of the first tool.

One aspect of the invention provides a method for making a subsurface measurement in a wellbore. The method includes a)disposing a tool within a wellbore traversing a sufsurface formation, the tool including, a first tool including a first plurality of pads to be positioned against a surface of the wellbore each of the pads having a first plurality of electrodes disposed thereon to emit electric current between the electrodes and a second plurality of electrodes disposed thereon between the first plurality of electrodes to measure an electromagnetic parameter; a second tool including a second plurality of pads to be positioned against a surface of the wellbore, each of the pads having a first plurality of electrodes disposed thereon to emit electric current between the electrodes and a second plurality of electrodes disposed thereon between the first plurality of electrodes to measure an electromagnetic parameter, the second tool being longitudinally offset from the first tool and the second plurality of pads of the second tool being rotationally offset relative to the first plurality of pads of the first tool; b) emitting current between the first plurality of electrodes on at least one pad on the first tool and between the first plurality of electrodes at lease one pad on the second tool when each at least one pad is positioned against a surface of the wellbore; and c) measuring an electromagnetic parameter with the second plurality of electrodes on the at least one pad on the first tool and with the second plurality of electrodes on the at least one on the second tool of step (b).

An implementation of the invention entails an imaging sonde having a first imaging tool and at least one additional imaging tool connected to the first imaging tool, the additional imaging tool having a fixed preset rotational offset and a significant vertical or longitudinal offset with respect to the first imaging tool in the tool string.

An OBMI sonde adapted to be disposed in a wellbore includes four pads which are adapted to extend radially when the sonde is in the wellbore, each of the four pads touching a wall of the wellbore with the pads extended radially in the wellbore. The OBMI sonde, four then pulled upwardly to the ground surface at the wellbore, and each of the pads generate a ‘track’ that is adapted to be displayed and/or recorded on an output record medium. A ‘track’ is comprised of a plurality of resistivity curves as a function of depth in the wellbore (five resistivity curves for the OBMI). Since there a four pads on the OBMI sonde, four ‘tracks’ will be recorded and/or displayed on the output record medium. However, since there are four pads on the OBMI sonde, there are four ‘regions’ disposed in between each of the four adjacent pads. As noted earlier, the four pads will survey four portions of the wellbore. However, there are no pads on the OBMI sonde in each of the four ‘regions’. As a result, since there are no pads on the OBMI sonde in each of the four ‘regions’, those portions of the wellbore will not be surveyed by the OBMI sonde. As a result, in order to solve this problem, the OBMI sonde includes a first imaging tool and at least one additional imaging tool connected to the first imaging tool via a special adapted, the additional imaging tool having a rotational offset and a significant vertical or longitudinal offset with respect to the first imaging tool in the OBMI tool string. That is, the first imaging tool will, for example, have four pads. The four pads on the first imaging tool will, for example, have a first pad at approximately zero (0) degrees azimuthally, a second pad at approximately ninety (90) degrees azimuthally with respect to the first pad, a third pad at approximately one-hundred eighty (180) degrees azimuthally with respect to the first pad, and a forth pad at approximately two-hundred seventy (270) degrees azimuthally with respect to the first pad. The additional imaging tool is connected to the first imaging tool via the special adapted. The additional imaging tool will be offset vertically or longitudinally in the wellbore with respect to the first imaging tool by a distance ‘d’ (i.e., the vertical offset). In additional to the vertical or longitudinal offset, the additional imaging tool will also have a rotational offset with respect to the first imaging tool. That is, the additional imaging tool will also have, for example, four pads. However, in addition to the vertical offset, the four pads of the additional imaging tool will, for example, have a first pad at approximately forty-five (45) degrees azimuthally with respect to the first pad of the first imaging tool, a second pad at approximately one-hundred thirty five (135) degrees azimuthally with respect to the first pad of the first imaging tool, a third pad at approximately two-hundred twenty five (225) degrees azimuthally with respect to the first pad of the first imaging tool, and a fourth pad at approximately three-hundred fifteen (315) degrees azimuthally with respect to the first pad of the first imaging tool. As a result, the four pads of the first imaging tool of the OBMI sonde will survey the four portions of the wellbore that are adjacent the four pads of the first imaging tool. However, in addition, the four pads of the additional imaging tool of the OBMI sonde will also survey the four portions of the wellbore that are adjacent the four ‘regions’ which are located in between the four pads of the first imaging tool. As a result, an output record medium generated by the OBMI sonde of the present invention will include eight tracks instead of the traditional four tracks of a prior art OBMI sonde.

As noted earlier, the first imaging tool is connected to at least one additional imaging tool via the adapter disposed between the first imaging tool and the additional imaging tool. The first imaging tool plugs into one end of the adapter, and the additional imaging tool plugs into the other end of the special adapter. The adapted is made in a special way such that, when the first imaging tool is plugged into the one end of the adapter and the additional imaging tool is plugged into the other end of the adapter, the additional imaging tool is ‘offset rotationally’ with respect to the first imaging tool; that is, there is a ‘rotational offset’ or ‘azimuthal offset’ or ‘angular offset’ of the additional imaging tool with respect to the first imaging tool.

As a result of the use of the special adapter disposed between the first imaging tool and the additional imaging tool in the wellbore, the additional imaging tool is ‘vertically offset’ with respect to the first imaging tool. However, in addition, the additional imaging tool is ‘rotationally offset’ with respect to the first imaging tool. When the additional imaging tool is ‘rotationally offset’ with respect to the first imaging tool, the four pads on the first imaging tool will, for example, have a first pad at approximately zero (0) degrees azimuthally, a second pad at approximately ninety (90) degrees azimuthally, a third pad at approximately one-hundred eighty (180) degrees azimuthally, and a fourth pad at approximately two-hundred seventy (270) degrees azimuthally. However, in addition, the four pads on the additional imaging tool will, for example, have a first pad at approximately forty-five (45) degrees azimuthally, a second pad at approximately one-hundred thirty five (135) degrees azimuthally, a third pad at approximately two-hundred twenty five (225) degrees azimuthally, and a fourth pad at approximately three-hundred fifteen (315) degrees azimuthally.

Further scope of applicability of the present invention will become apparent from the detailed description presented hereinafter. It should be understood, however, that the detailed description and the specific examples, while representing a preferred embodiment of the present invention, are given by way of illustration only, since various changes and modifications within the spirit and scope of the invention will become obvious to one skilled in the art from a reading of the following detailed description.

### BRIEF DESCRIPTION OF THE DRAWINGS

A full understanding of the present invention will be obtained from the detailed description of the preferred embodiment presented hereinbelow, and the accompanying drawings, which are given by way of illustration only and are not intended to be limitative of the present invention, and wherein:

FIGS. 1 through 4 illustrate a prior art Oil Based Mud Imaging (OBMI) sonde;

FIG. 4A illustrates an output record medium generated by the OBMI sonde of the prior art, the output recording medium having four tracks corresponding, relatively, to the four pads on the OBMI sonde;

FIG. 5 illustrates a dual Oil Based Mud Imaging sonde (hereinafter referred to as a ‘dual OBMI sonde’) of the present invention including a first imaging tool and a second additional imaging tool connected to the first imaging tool, the second additional imaging tool being rotationally and vertically offset with respect to the first imaging tool;

FIG. 6 illustrates a top view of the first imaging tool of the dual OBMI sonde of FIG. 5 taken along section lines 6-6 of FIG. 5;

FIG. 7 illustrates a top view of the second imaging tool of the dual OBMI sonde of FIG. 5 taken along section lines 7-7 of FIG. 5;

FIG. 8A illustrates another view of the dual OBMI sonde of FIG. 5;

FIG. 8B illustrates a view of the first imaging tool of the dual OBMI sonde of FIG. 8A;

FIG. 8C illustrates a view of the second additional imaging tool of the dual OBMI sonde of FIG. 8A;

FIG. 9 illustrates a top view of the prior art OBMI sonde of FIGS. 1 and 3, this top view showing an OBMI sonde having four pads, each pad adapted to touch a side wall of the wellbore;

FIG. 10 illustrates another top view of the first imaging tool of the dual OBMI sonde of FIG. 5 taken along section lines 6-6 of FIG. 5 (this is similar to the top view shown in FIG. 6);

FIG. 11 illustrates a construction of the ‘special adapter’ which interconnects the second additional imaging tool to the first imaging tool of the dual OBMI sonde of FIG. 5 of the present invention;

FIG. 12 illustrates a comparison of an output record medium generated by the prior art OBMI sonde of FIGS. 1 through 4 showing four tracks against the output record medium generated by the dual OBMI sonde of the present invention showing eight tracks; and

FIGS. 13 and 14 illustrate a more detailed view of the output record medium generated by the dual OBMI sonde of the present invention showing eight tracks including four tracks generated by the four pads on the first imaging tool and four additional tracks generated by the four pads on the second additional imaging tool of the dual OBMI sonde of the present invention.

FIG. 15 is a schematic showing a side view of a tool pad of the invention obtaining an electromagnetic measurement.

FIG. 16 is a front view of a pad embodiment of the invention similar to the pad of FIG. 15.

### DETAILED DESCRIPTION

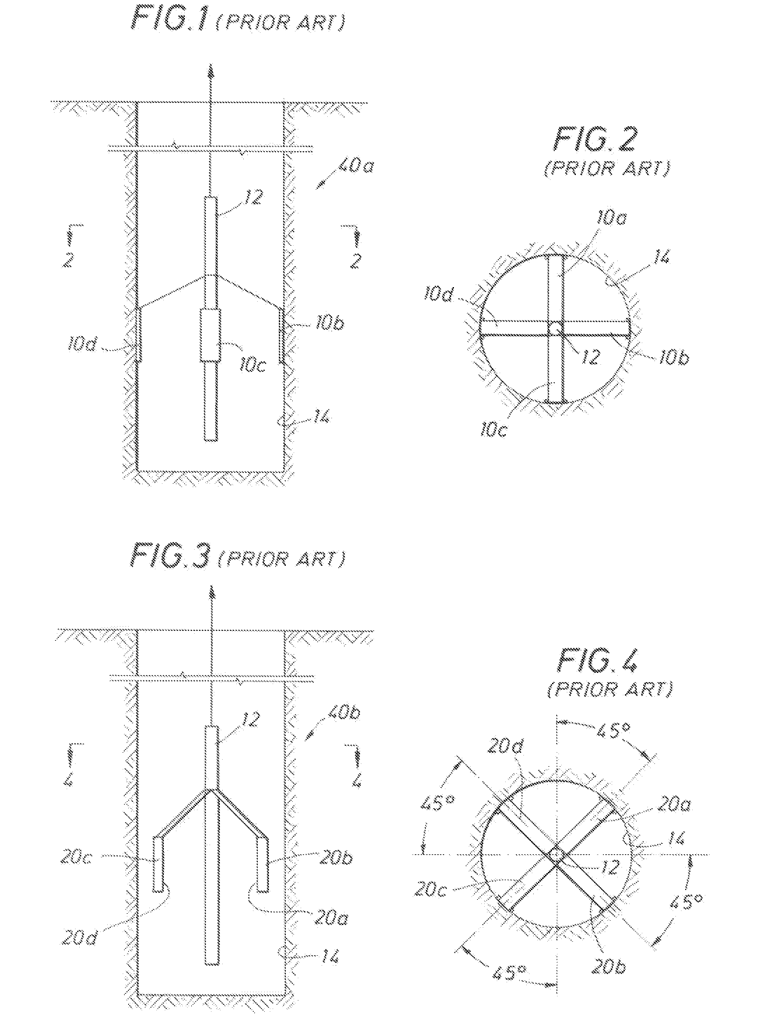

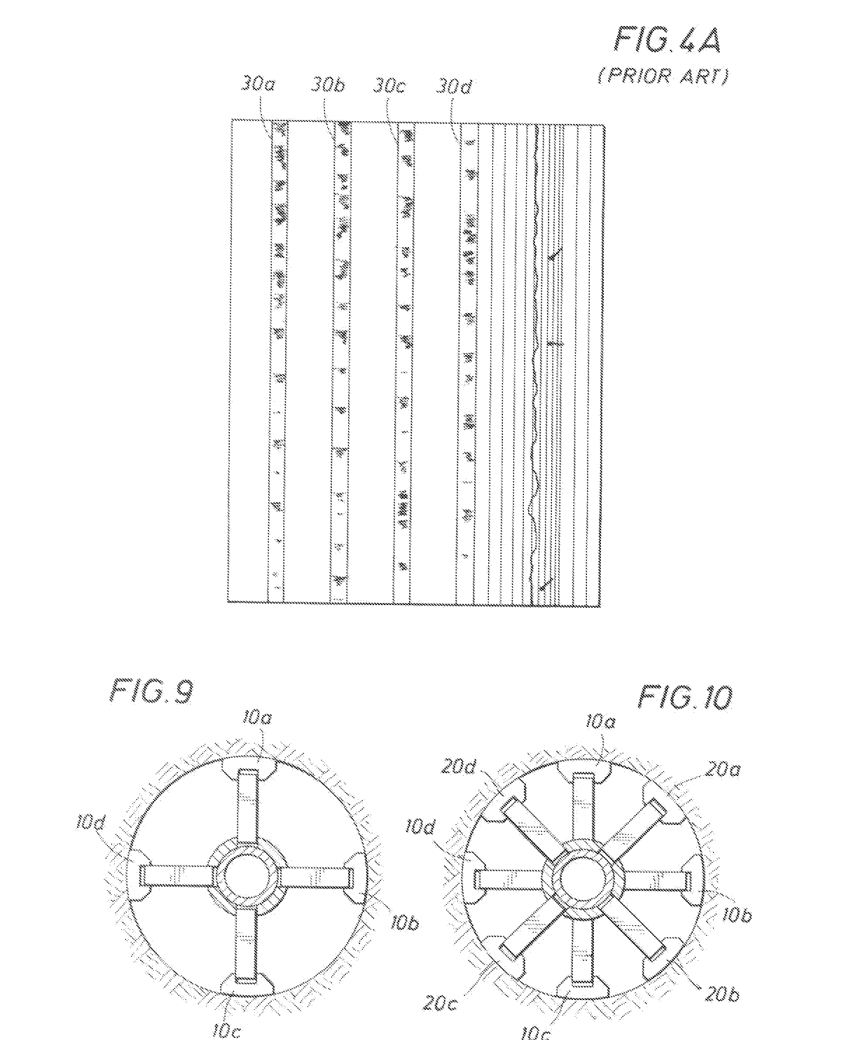

Referring to FIGS. 1 and 2, a first prior art Oil Based Mud Imaging (OBMI) sonde 40a is illustrated. In FIG. 1, the first OBMI sonde 40a includes four pads 10a-10d adapted to touch a wall of the wellbore when the OBMI sonde is pulled upwardly to a surface of the wellbore. The OBMI sonde 40a of FIG. 1 is owned and operated by Schlumberger Technology Corporation of Houston, Texas. The four pads include a first pad 10a (not shown in FIG. 1) mounted on a central shaft 12, a second pad 10b mounted to the central shaft 12, a third pad 10c and a fourth pad 10d both mounted to the central shaft 12. In FIG. 1, the four pads 10a-10d are shown in their extended position, the pads extending radially outward until the pads touch a wall 14 of the wellbore. When the pads touch the wall 14 of the wellbore, the OBMI sonde 40a of FIG. 1 is pulled upwardly to a surface of the wellbore and, responsive thereto, an output record medium (see FIG. 4A) is generated having four tracks corresponding, respectively, to the four pads 10a-10d on the OBMI sonde. The four tracks each represent resistivity curves as a function of depth in the wellbore. The four tracks will be discussed later in this specification.

In FIG. 2, a top view of the first OBMI sonde 40a of FIG. 1, taken along section lines 2-2 of FIG. 1, is illustrated. In FIG. 2, the first OBMI sonde 40a includes the four pads including pad 10a and pad 10b and pad 10c and pad 10d. The four pads 10a-10d are each connected to the central shaft 12, the pads 10a-10d being shown in their extended position. That is, the pads 10a-10d have been extended radially outward until the pads 10a-10d each touch a wall 14 of the wellbore. In this position, the first OBMI sonde 40a of FIG. 2 is ready to be pulled upwardly to a surface of the wellbore and, responsive thereto, the output record medium including the four tracks of FIG. 4A will be generated (one track for each pad 10a-10d).

Referring to FIGS. 3 and 4, a second prior art Oil Based Mud Imaging (OBMI) sonde 40b of FIGS. 1 and 2 is illustrated. However, in FIGS. 3 and 4, the pads are rotationally offset.

In FIG. 3, the second OBMI sonde 40b includes four pads 20a-20d adapted to touch a wall 14 of the wellbore when the OBMI sonde is pulled upwardly to a surface of the wellbore. The four pads include a first pad 20a mounted on a central shaft 12, a second pad 20b mounted to the central shaft 12, a third pad 20c and a fourth pad 20d both mounted to the central shaft 12. In FIG. 3, the four pads 20a-20d are shown in their extended position, the pads extending radially outward until the pads touch a wall 14 of the wellbore. When the pads touch the wall 14 of the wellbore, the second OBMI sonde 40b of FIG. 3 is pulled upwardly to a surface of the wellbore and, responsive thereto, an output record medium (see FIG. 4A) is generated having four tracks corresponding, respectively, to the four pads 20a-20d on the OBMI sonde. The four tracks each represent resistivity curves as a function of depth in the wellbore. The four tracks will be discussed later in this specification. In FIG. 3, however, the pads 20a-20d have been ‘rotationally offset’; that is, the pads 20a-20d have been rotated azimuthally until the pads 20a-20d are offset azimuthally by an angle of approximately 45 degrees relative to the position of the pads 10a-10d in FIGS. 1 and 2. This ‘rotationally offset’ feature is best illustrated in FIG. 4.

In FIG. 4, a top view of the second OBMI sonde 40b of FIG. 3, taken along section lines 4-4 of FIG. 3, is illustrated. In FIG. 4, the second OBMI sonde 40b includes the four pads including pad 20a and ad 20b and pad 20c and pad 20d. The four pads 20a-20d are each connected to the central shaft 12, the pads 20a-20d being shown in their extended position. That is, the pads 20a-20d have been extended radially outward until the pads 20a-20d each touch a wall 14 of the wellbore. In this position, the OBMI sonde 40b of FIG. 3 is ready to be pulled upwardly to a surface of the wellbore and, responsive thereto, the output record medium including the four tracks of FIG. 4A will be generated (one track for each pad 20a-20d). In FIG. 4, the first pad 20a has been ‘offset rotationally’ or ‘offset azimuthally’ by an angle of approximately 45 degrees with respect to the position of pad 10a of FIG. 2. Similarly, the second pad 20b has been ‘offset rotationally’ by an angle of approximately 45 degrees with respect to the position of pad 10b of FIG. 2. The third pad 20c has been ‘offset rotationally’ by an angle of approximately 45 degrees with respect to the position of pad 10c of FIG. 2. The fourth pad 20d has been ‘offset rotationally’ for an angle of approximately 45 degrees with respect to the position of pad 10d of FIG. 2. However, the second OBMI sonde 40b of FIGS. 3 and 4 is identical to the first OBMI sonde 40a of FIGS. 1 and 2, even though the pads 20a-20d in FIG. 4 have been ‘rotationally offset’ or ‘azimuthally offset’ or ‘angularly offset’ relative to the position of pads 10a-10d in FIG. 2.

Referring to FIG. 4A, the output record medium produced by the OBMI sonde 40a and 40b of FIGS. 1-4 is illustrated. In FIG. 4A, the output record medium includes four tracks, a first track 30a corresponding to pad 10a or 20a, a second track 30b corresponding to pad 10b or 20b, a third track 30c corresponding to pad 10c or 20c, and a fourth track 30d corresponding to pad 10d or 20d. When the OBMI sonde 40a or 40b of FIGS. 1-4 is pulled upwardly to a surface of the wellbore, an output record medium is generated which includes the four tracks 30a-30d. Each track 30a-30d includes a plurality of resistivity curves as a function of depth. That is, each pad 10a-10d and 20a-20d includes a plurality of button pairs (typically five button pairs in OBMI). When the OBMI sonde 40a or 40b is pulled upwardly to the surface of the wellbore, the plurality of button pairs generate a corresponding plurality of resistivity curves as a function of depth in the wellbore. Since there are typically five button pairs on each pad 10a-10d/20a-20d, five resistivity curves will be generated for each pad, one resistivity curve as a function of depth in the wellbore for each button pair on each pad. The five button pairs on each pad comprise a ‘track’. Therefore, for each pad, the five resistivity curves generated by each pad will comprise a ‘track’. In FIG. 4A, four ‘tracks’ are illustrated, tracks 30a-30d. Each ‘track’ 30a-30d will provide an indication of resistivity as a function of depth in the wellbore for each corresponding pad 10a-10d/20a-20d on the OBMI sonde 40a or 40b.

Referring to FIGS. 5, 6, and 7, the dual OBMI sonde system 41, in accordance with the present invention, is illustrated.

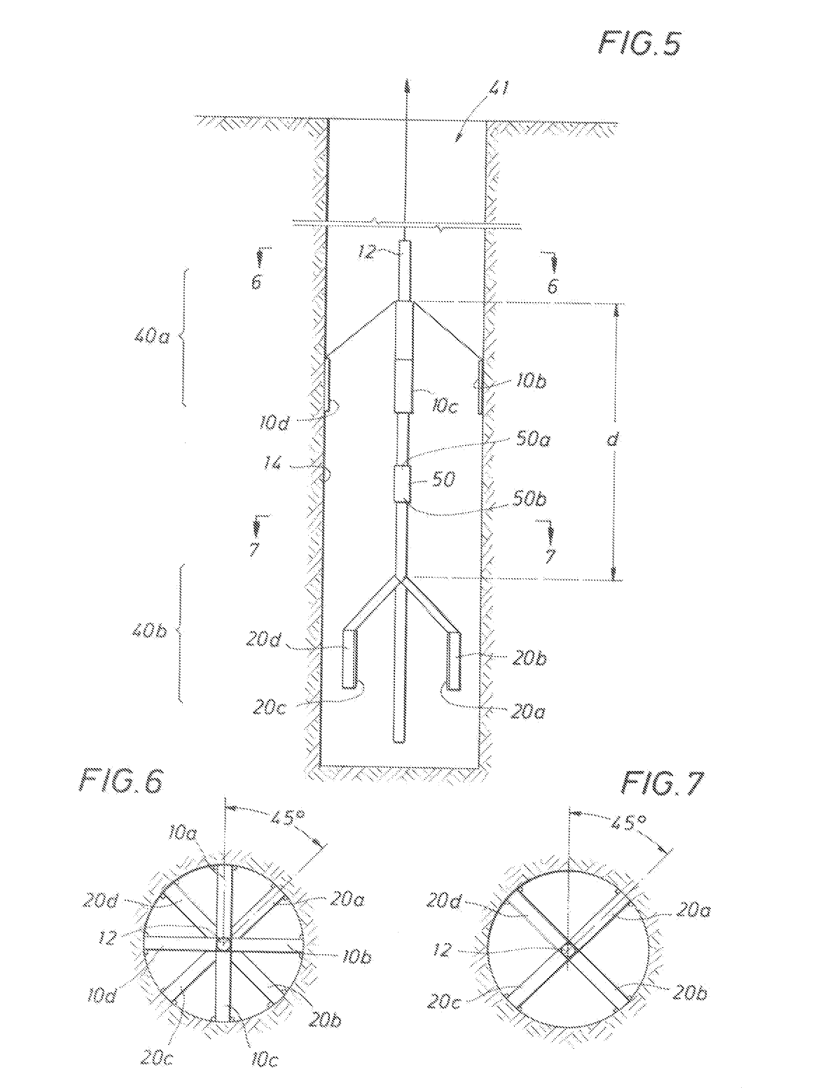

In FIG. 5, the dual OBMI sonde system 41 includes the first OBMI sonde 40a connected to the second OBMI sonde 40b via a special adapter 50. The first OBMI sonde 40a of FIGS. 1 and 2 including pads 10a-10d is connected to the second OBMI sonde 40b of FIGS. 3 and 4 including pads 20a-20d via a special adapter 50. That is, the first OBMI sonde 40a of FIGS. 1 and 2 is connected to an upper end 50a of the special adapter 50, and the second OBMI sonde 40b of FIGS. 3 and 4 is connected to a lower end 50b of the special adapter 50. When the special adapter 50 interconnects the first OBMI sonde 40a of FIGS. 1 and 2 at its upper end 50a to the second OBMI sonde 40b of FIGS. 3 and 4 at its lower end 50b, the second OBMI sonde 40b including pads 20a-20d is ‘rotationally offset’ by a predetermined angle (in this embodiment, approximately 45 degrees) relative to the first OBMI sonde 40a including pads 10a-10d. In addition, when the special adapter 50 interconnects the first OBMI sonde 40a of FIGS. 1 and 2 at its upper end 50a to the second OBMI sonde 40b of FIGS. 3 and 4 at its lower end 50b, the second OBMI sonde 40b including pads 20a-20d is ‘vertically offset’ or ‘longitudinally offset’ by a distance ‘d’ from the first OBMI sonde 40a including pads 10a-10d. For example, in FIG. 5, note that the second OBMI sonde 40b is spaced by a vertical or longitudinal distance ‘d’ from the first OBMI sonde 40a. The term ‘vertically offset’ refers to the distance ‘d’ in FIG. 5 when the first and second OBMI tools 40a and 40b are disposed in the wellbore. However, in any event, the second OBMI tool 40b is ‘longitudinally offset’ from the first OBMI tool 40a along the longitudinal axial length of the dual OBMI sonde 40 of FIG. 5 because the second OBMI tool 40b is spaced by a distance ‘d’ from the first OBMI tool 40a along the longitudinal axial length of the dual OBMI sonde 41. The ‘rotationally offset’ feature can best be seen in FIGS. 6 and 7 of the drawings.

In FIG. 6, a top view of the dual OBMI sonde 41 of FIG. 5, taken along section lines 6-6 of FIG. 5, is illustrated. In FIG. 6, recall that the first OBMI sonde 40a included pads 10a, 10b, 10c, and 10d (see FIG. 2). In FIG. 6, the first pad 10a of the first OBMI sonde 40a is azimuthally located at approximately zero (0) degrees, the second pad 10b is azimuthally located at approximately ninety (90) degrees relative to pad 10a, the third pad 10c is azimuthally located at approximately one-hundred eighty (180) degrees relative to pad 10a, and the fourth pad 10d is azimuthally located at approximately two-hundred seventy (270) degrees relative to pad 10a. However, in FIG. 6, recall that the second OBMI sonde 40b included pads 20a, 20b, 20c, and 20d (see FIG. 4). In FIG. 6, the second OBMI sonde 40b is ‘rotationally offset’ relative to the first OBMI sonde 40a because the pads 20a-20d of the second OBMI sonde 40b are rotated clockwise by an angle of approximately 45 degrees with respect to the pads 10a-10d of the first OBMI sonde 40a. That is, in order to fully understand the ‘rotationally offset’ feature, note the following angular dimensions: in FIG. 6, the first pad 20a of the second OBMI sonde 40b is azimuthally located at approximately fourty five (45) degrees relative to pad 10a of the first OBMI sonde 40a, the second pad 20b is azimuthally located at approximately 45 degrees relative to pad 10b, the third pad 20c is azimuthally located at approximately 45 degrees relative to pad 10c, and the fourth pad 20d is azimuthally located at approximately 45 degrees relative to pad 10d.

In FIG. 7, a top view of the second OBMI sonde 40b of FIG. 5 taken along section lines 7-7 of FIG. 5 is illustrated. In FIG. 7, the second OBMI sonde 40b, including pads 20a-20b (of FIG. 4), is shown as having pads 20a-20d that are ‘rotationally offset’ by an angle of approximately 45 degrees with respect to the pads 10a-10d of the first OBMI sonde 40a. In particular, in FIG. 7, pad 20a is is rotated clockwise by an angle of approximately 45 degrees with respect to pad 10a of the first OBMI sonde 40a. Similarly, pad 20b is rotated clockwise by an angle of approximately 45 degrees with respect to pad 10b of the first OBMI sonde 40a. Pad 20c is rotated clockwise by an angle of approximately 45 degrees with respect to pad 10c of the first OBMI sonde 40a. Pad 20d is rotated clockwise by an angle of approximately 45 degrees with respect to pad 10d of the first OBMI sonde 40a.

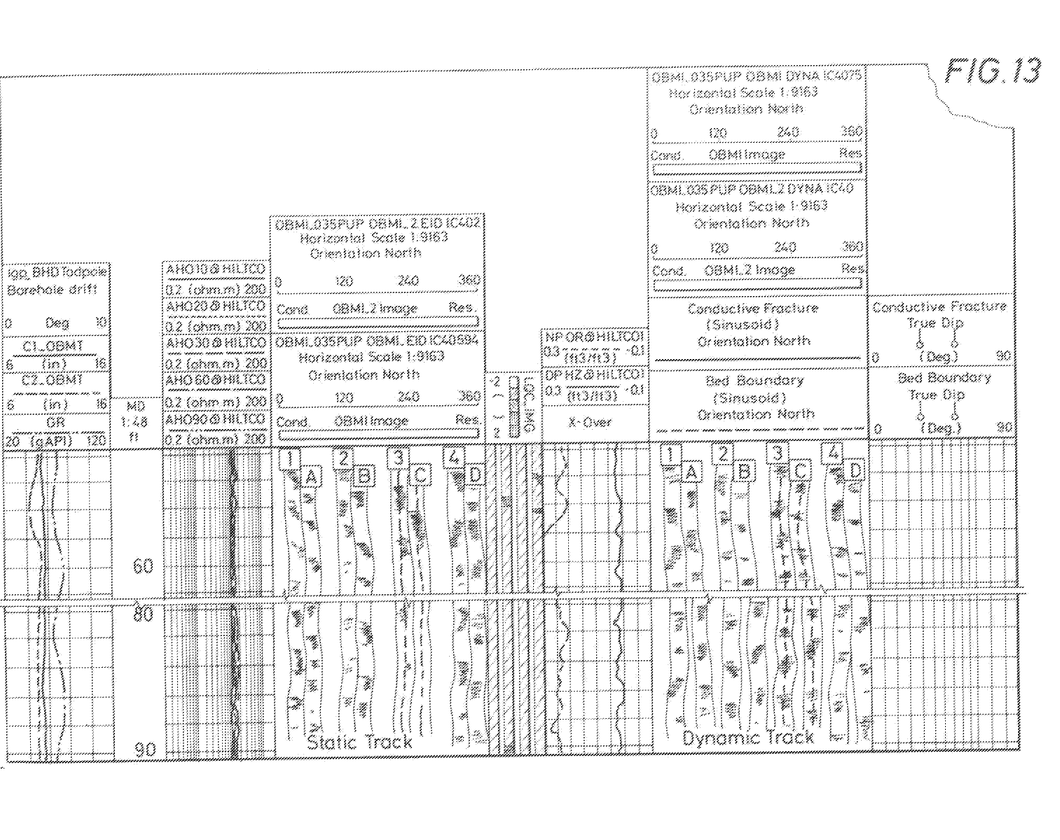

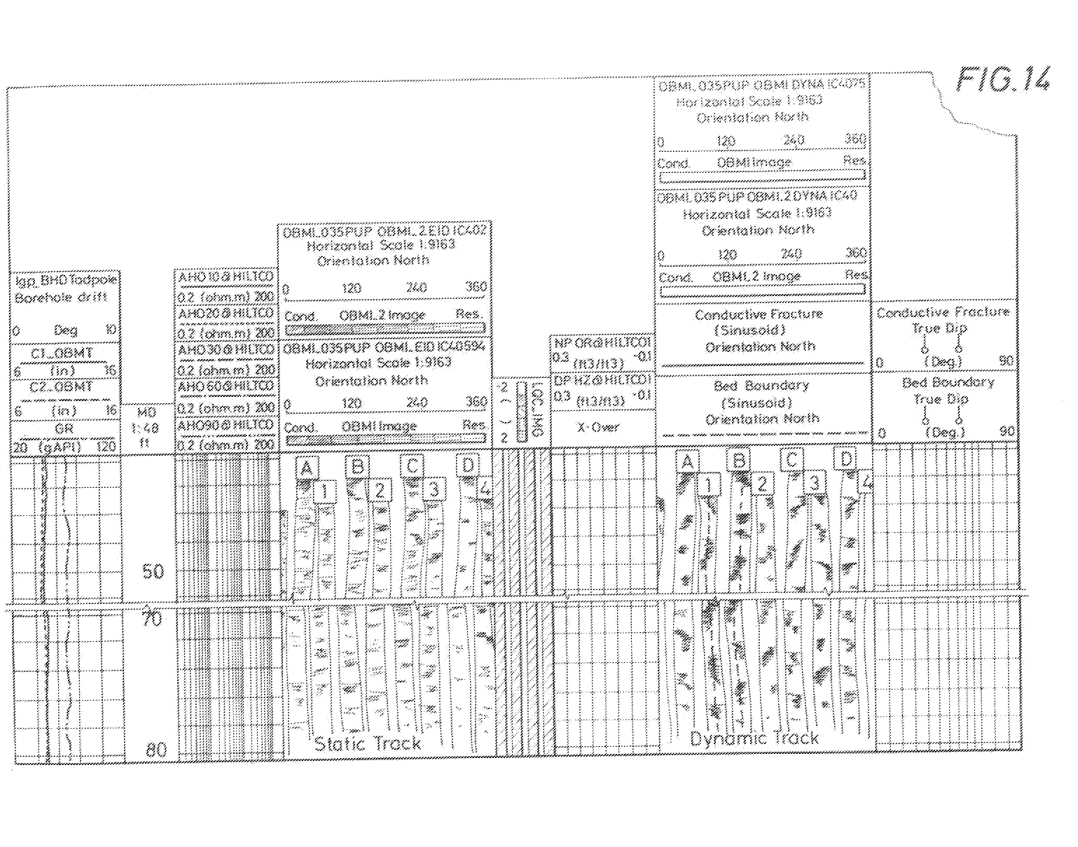

In FIGS. 5 and 6, when the dual OBMI sonde 41 of FIG. 5 is pulled upwardly to a surface of the wellbore, the pads 10a, 10b, 10c, and 10d of the first OBMI sonde 40a will survey the wall 14 of the wellbore at the following azimuthal or angular locations relative to the location of pad 10a: zero (0) degrees using pad 10a, ninety (90) degrees using pad 10b, one-hundred eighty (180) degrees using pad 10c, and two-hundred seventy (270) degrees using pad 10d. However, the pads 20a, 20b, 20c, and 20d of the second OBMI sonde 40b will survey the wall 14 of the wellbore to the following azimuthal or angular locations relative to the location of pad 10a: fourty five (45) degrees using pad 20a, one-hundred thirty five (135) degrees using pad 20b, two-hundred twenty five (225) degrees using pad 20c, and three-hundred fifteen (315) degrees using pad 20d. The term “survey the wall 14 of the wellbore” means that the pads 10a-20d will touch and rub-against the wall 14 of the wellbore when the dual OBMI sonde 40 is being pulled upwardly to a surface of the wellbore; and, responsive thereto, an output record medium will be generated (such a well log or other graphical chart) where the output record medium will display a plurality of ‘tracks’ (such as the eight tracks seen in FIG. 13) which correspond, relatively, to the plurality of pads 10a-10d/20a-20d used by the dual OBMI tool 41 of FIG. 5.

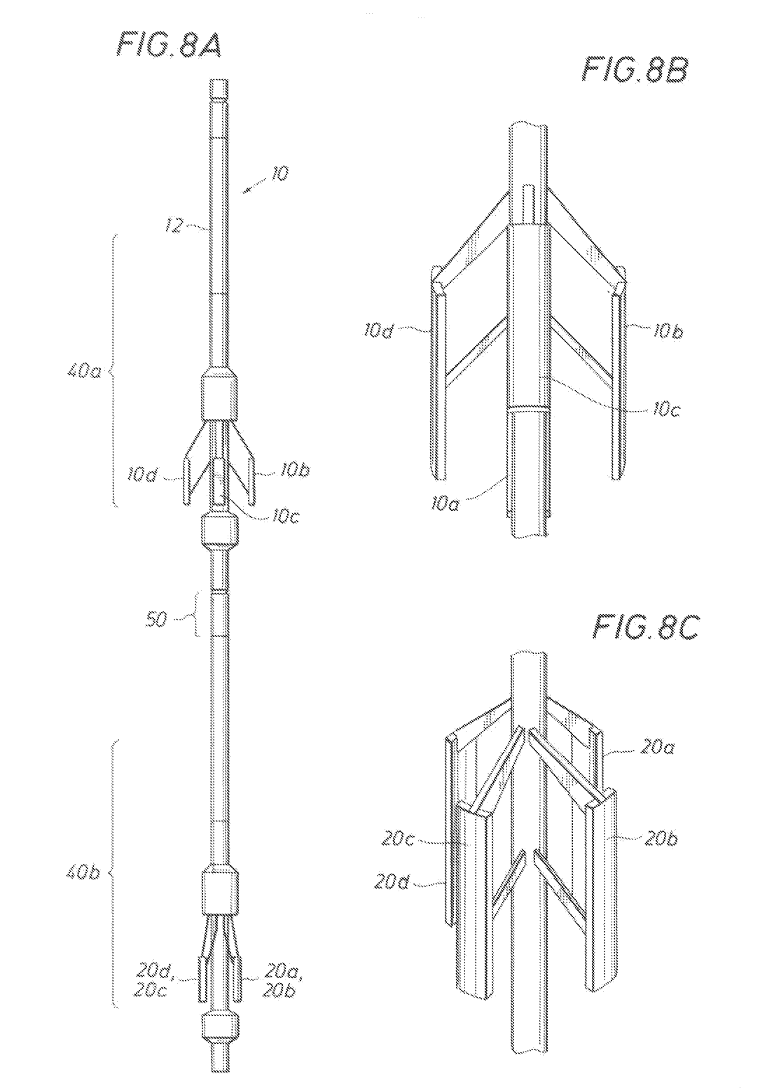

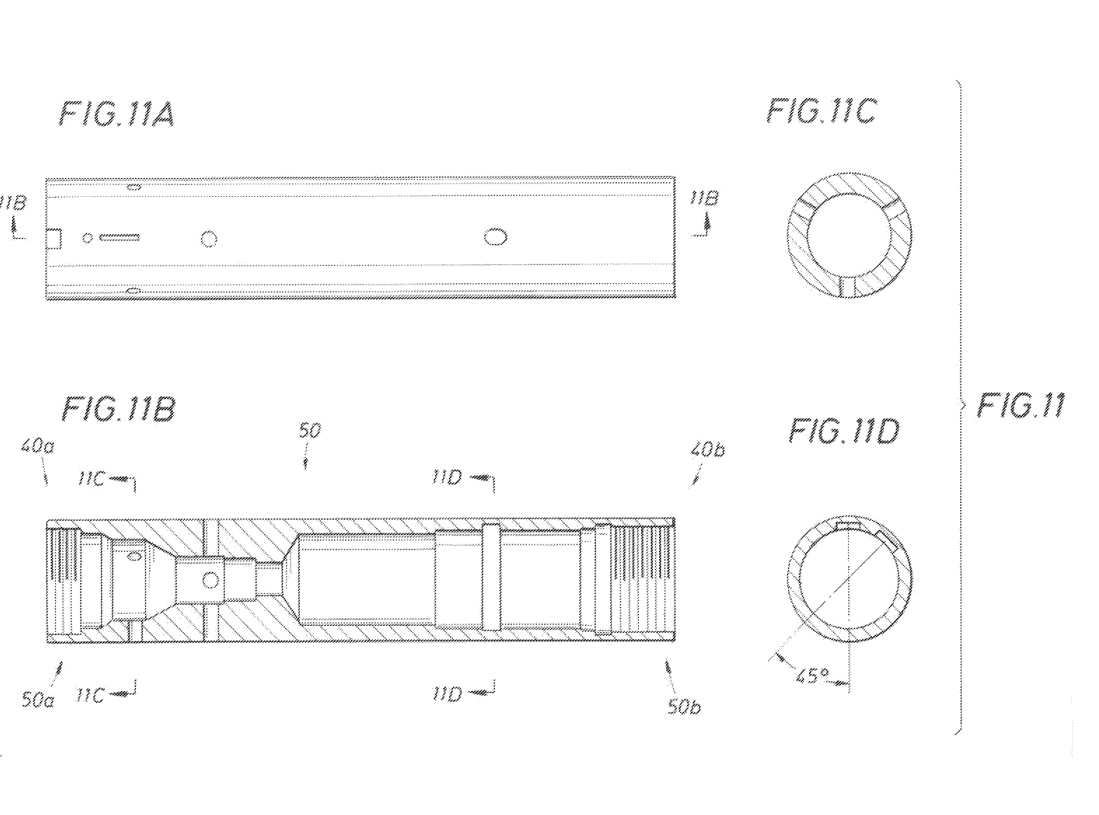

Referring to FIGS. 8A, 8B, and 8C, another more realistic view of the dual OBMI sonde 41 in accordance with the present invention is illustrated. In FIG. 8A, the dual OBMI sonde 41 includes the first OBMI tool 40a connected to the second OBMI 40b via a special adapter 50. The first OBMI tool 40a includes pads 10a, 10b, 10c, and 10d. The second OBMI tool 40b includes pads 20a, 20b, 20c, and 20d. The pads 10a, 10b, 10c, and 10d of the first OBMI tool 40a are shown in their extended position (extended radially outward) for touching the wall 14 of the wellbore. The angular or azimuthal position of the pads 10a, 10b, 10c, and 10d on the first OBMI tool 40a relative to pad 10a of the first OBMI tool 40a are: 0 degrees for pad 10a, 90 degrees for pad 10b, 180 degrees for pad 10c, and 270 degrees for pad 10d. The pads 20a, 20b, 20c, and 20d of the second OBMI tool 40b are shown in their extended position (extended radially outward) for touching the wall 14 of the wellbore. The angular or azimuthal position of the pads 20a, 20b, 20c, and 20d on the second OBMI tool 40b relative to pad 10a of the first OBMI tool 40a are: 45 degrees for pad 20a, 135 degrees for pad 20b, 225 degrees for pad 20c, and 315 degrees for pad 20d. As a result, the pads 20a-20d of the second OBMI too 40b will survey (i.e., develop tracks like those shown in FIG. 13) the azimuthally oriented regions of the wellbore which are disposed in-between adjacent pads (i.e., in-between adjacent pads 10a-10b, 10b-10c, 10c-10d, and 10d-10a) of the first OBMI tool 40a. Therefore, instead of generating four tracks similar to the four tracks shown in FIG. 4A generated by the prior art OBMI tool of FIGS. 1-4, the dual OBMI sonde 41 of the present invention will generate eight tracks similar to the eight tracks shown in FIG. 13. In FIG. 8B, the four pads 10a, 10b, 10c, and 10d of the first OBMI tool 40a are shown in their extended position, pad 10a being at 0 degrees, pad 10b being 90 degrees relative to pad 10a, pad 10c being at 180 degrees relative to pad 10a, and pad 10d being at 270 degrees relative to pad 10a. In FIG. 8C, the four pads 20a, 20b, 20c, and 20d of the second OBMI tool 40b are shown in their extended position, pad 20a being at 45 degrees relative to pad 10a, pad 20b being at 135 degrees relative to pad 10a, pad 20c being at 225 degrees relative to 10a, and pad 20d being at 315 degrees relative to pad 10a.

Referring to FIG. 9, a more realistic top view of the prior art OBMI sonde 40a of FIG. 1, taken along section lines 2-2 of FIG. 1, is illustrated. Note that the pads 10a-10d are in their extended position adapted to touch an internal wall 14 of the wellbore. Pad 10a is located at an azimuthal angle of 0 degrees relative to pad 10a, pad 10b is located at 90 degrees relative to pad 10a, pad 10c is located at 180 degrees relative to pad 10a, and pad 10d is located at 270 degrees relative to pad 10a.

Referring to FIG. 9, a more realistic top view of the dual OBMI sonde 41 of the present invention of FIG. 5 taken along section lines 6-6 of FIG. 5 is illustrated. Compare FIG. 6 with FIG. 10 and note that the pads 10a-10d, 20a-20d are in their extended position adapted to touch an internal wall 14 of the wellbore. Pads 10a-10d belong to the first OBMI tool 40a, and pads 20a-20d belong to the second OBMI tool 40b. Pad 10a is located at an azimuthal angle of 0 degrees relative to pad 10a, pad 20b is located at 45 degrees relative to pad 10a, pad 10b is located at 90 degrees relative to pad 10a, pad 20b is located at 135 degrees relative to pad 10a, pad 10c is located at 180 degrees relative to pad 10a, pad 20c is located at 225 degrees relative to pad 10a, pad 10d is located at 270 degrees relative to pad 10a, and pad 20d is located at 315 degrees relative to pad 10a. Yet, pads 20a-20d of the second OBMI tool 40b are ‘vertically offset’ or ‘longitudinally offset’ from pads 10a-10d of the first OBMI tool 40a when the dual OBMI sonde 41 is disposed in a wellbore. As a result, the four pads 10a-10d of the first imaging tool 40a of the dual OBMI sonde 41 will survey the four portions of the wellbore that are adjacent to the four pads 10a-10d. However, in addition, the four pads 20a-20d of the additional imaging tool 40b of the dual OBMI sonde 41 will also survey the four portions of the wellbore that are adjacent to the four ‘regions’ which are located in between the four pads 10a-10d of the first imaging tool 40a.

Referring to FIG. 11, a construction of the special adapter 50 of FIGS. 5 and 8A is illustrated. In FIG. 11, the special adapter 50 includes a first end 50a adapted to receive an end of the first OBMI tool 40a and a second end 50b adapted to receive an end of the second OBMI tool 40b. When the end of the first OBMI tool 40a is plugged into the first end 50a of the special adapter 50, and when the end of the second OBMI tool 40b is plugged into the second end 50b of the special adapter 50, the pads 20a-20d of the second OBMI tool 40b will automatically be ‘rotationally offset’ or ‘azimuthally offset’ relative to the pads 10a-10d of the first OBMI tool 40a. This is because the special adapter 50 is specially manufactured in order to ‘rotationally offset’ the pads 20a-20d of the second OBMI tool 40b relative to the pads 10a-10d of the first OBMI tool 40a (where the term ‘rotationally offset’ is meant to indicate that pad 20a is rotated clockwise an azimuthal angle of 45 degrees with respect to pad 10a, pad 20b is rotated clockwise an azimuthal angle of 45 degrees with respect to pad 10b, pad 20c is rotated clockwise an azimuthal angle of 45 degrees with respect to pad 10c, and pad 20d is rotated clockwise an azimuthal angle of 45 degrees with respect to pad 10d).

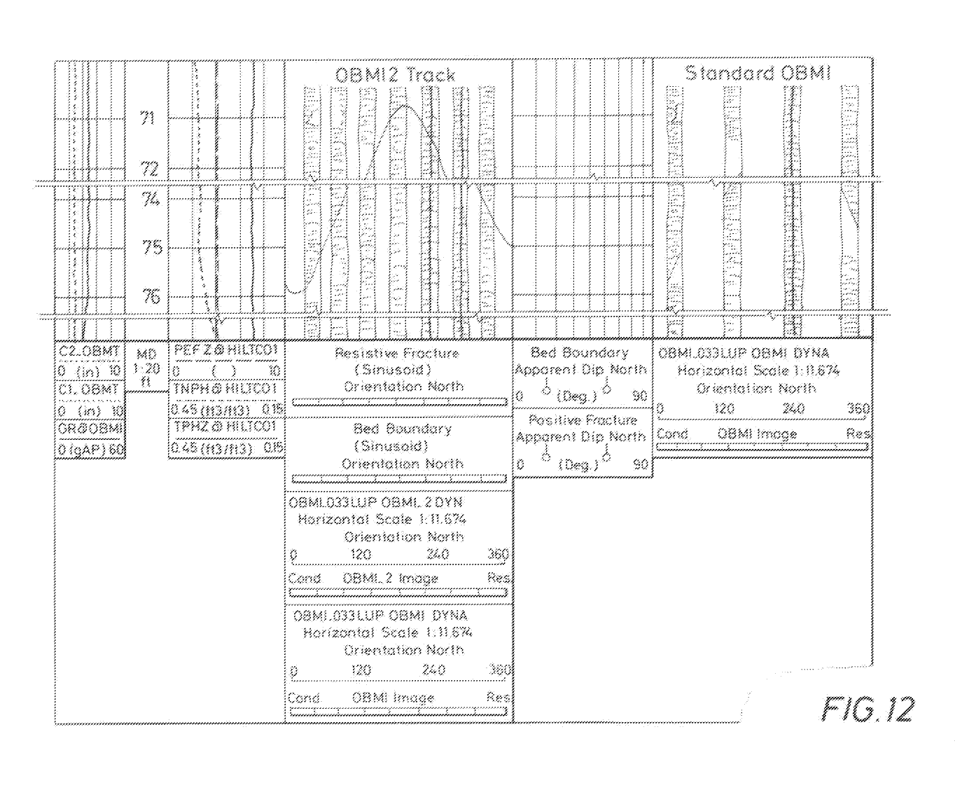

Referring to FIG. 12, a comparison of output records is illustrated whereby an output record medium generated by the prior art OBMI sonde of FIGS. 1 through 4 showing four (4) tracks is being compared against the output record medium generated by the dual OBMI sonde 41 of the present invention showing eight (8) tracks. In FIG. 12, the presentation shows an image acquired by the dual OBMI sonde 41 of the present invention having eight (8) tracks (labeled ‘OBMI2 track’) and a standard prior art OBMI tool having four (4) tracks (labeled ‘Standard OBMI’). Notice the much more distinctly visible high apparent angle fractures (see the sinusoid in FIG. 12) in the ‘OBMI2 track’ image.

Referring to FIGS. 13 and 14, a more detailed view of the output record medium generated by the dual OBMI sonde 41 of the present invention is illustrated, FIGS. 13 and 14 showing eight tracks including four tracks generated by the four pads 10a-10d on the first imaging tool 40a and four additional tracks generated by the four pads 20a-20d on the second additional imaging tool 40b of the dual OBMI sonde 41 of the present invention.

In FIG. 13, this presentation shows images acquired by dual OBMI sonde 41 (i.e., the ‘OBMI2’) of the present invention. The static and dynamic tracks are labeled accordingly. The image segment acquired by each pad has been labeled as 1, 2, 3, 4 (acquired by the first tool 40a) and labeled as A, B, C, D, (acquired by the second tool 40b). Looking at image segments from Pads 1, 2, 3, and 4 in the Static Track, it is observed that, at depth xx,x58-71 ft, the image segments are almost uniform in color. This corresponds to a time frame during data acquisition when the tool was stuck in the borehole, but continued to record data, and then pulled free. Once processed, this data appears as a “smear” on the image, as seen at depth xx,x58-71 ft in the image segments from Pads 1, 2, 3, and 4. When the first tool was stuck at the depth xx,x71 ft, the second tool (with fixed vertical offset from the first tool) was stuck at depth xx,x88 ft and caused a “smear” at depth xx,x75-88 ft (image segments from Pads A, B, C, and D). However, when the first tool had passed this interval earlier, neither tool was stuck and the first tool had recorded a true data image (see image segments from Pads 1, 2, 3, and 4 at depth xx,x75-88 ft). Further, once the tools had broken free, the second tool passed through the zone that the first tool had “smeared” (depth xx,x58-71 ft) and the second tool recorded a true data image (image segments from Pads A, B, C, and D). In this way, the second tool compensated for the loss of data by the first tool, and vice versa, and thus provided complete vertical coverage.

In FIG. 14, this presentation also shows images acquired by the dual OBMI sonde 41 (i.e., the OBMI2) of the present invention. The static and dynamic tracks are labeled accordingly. The image segment acquired by each pad has been labeled 1, 2, 3, 4 (acquired by the first tool) and labeled as A, B, C, D (acquired by the second tool). Looking at image segments from Pads 1, 2, 3, and 4 in the Static Track, it is observed that at depth xx,x45.5-61.5 ft the image segments have only slight variation in color. This corresponds to a time frame during data acquisition when the tool was stuck in the borehole, but continued to record data, and then pulled free. Once processed, this data appears as a “smear” on the image, as seen at depth xx,x45.5-61.5 ft in the image segments from Pads 1, 2, 3 and 4. When the first tool was stuck at the depth xx,x61.5 ft the second tool (with fixed vertical offset from the first tool) was stuck at depth xx,x78.5 ft and caused a “smear” at depth xx,x62.5-78.5 ft (image segments from Pads A, B, C and D). However, when the first tool had passed this interval earlier, neither tool was stuck and the first tool had recorded a true data image (see image segments from Pads 1, 2, 3 and 4 at depths xx,x62.5-78.5 ft). Further, once the tools had broken free, the second tool passed through the zone that the first tool had “smeared” (depth xx,x45.5-61.5 ft) and the second tool recorded a true data image (image segments from Pads A, B, C and D). In this way, the second tool compensated for the loss of data by the first tool, and vice versa, and thus provided complete vertical coverage.

A functional description of the operation of the dual OBMI sonde 41 of FIG. 5 of the present invention will be set forth in the following paragraph with reference to FIGS. 1 through 13 of the drawings.

The dual OBMI sonde system 41 of FIG. 5 is positioned in a wellbore as shown. The pads 10a-10d of the first OBMI tool 40a are located at the following angular positions relative to pad 10a: 0 degrees, 90 degrees, 180 degrees, and 270 degrees; however, the pads 20a-20d of the second OBMI tool 40b are located at the following angular positions relative to pad 10a: 45 degrees, 135 degrees, 225 degrees, and 315 degrees. An operator at the surface of the wellbore will now pull the dual OBMI sonde 41 of FIG. 5 upwardly to the surface. The pads 10a-10d and 20a-20d are actually touching the side walls of the wellbore 14 when the dual OBMI sonde 41 is pulled upwardly to the surface of the wellbore. Recalling that pads 10a-10d of the first OBMI sonde 40a of FIG. 4 will touch the side walls of the wellbore at the following angular degrees: 0, 90, 180, and 270; and recalling that the pads 20a-20d of the second OBMI sonde 40b of FIG. 5 will touch the side walls of the wellbore at the following angular degrees: 45, 135, 225, 315, when the dual OBMI sonde 41 of FIG. 5 is pulled upwardly to the surface of the wellbore, a new and novel output record medium will be generated and that new and novel output record medium will have the eight (8) tracks shown in FIG. 13 instead of the four tracks in FIG. 4A generated by the prior art OBMI tool of FIGS. 1-4. As a result, more wellbore features can be seen on the eight-track output record medium of FIG. 13. That is, since there are eight tracks in FIG. 13 instead of the four tracks in FIG. 4A, more Earth formation features disposed on the side wall 13 of the wellbore of FIG, 5 will be visible on the eight tracks of the output record medium shown in FIG. 13.

As discussed above, the present invention is primarily aimed at OBM and SBM operations, entailing the measurement of voltage differences made independently by the upper tool 40a and independently by the lower tool 40b. Each tool pad (10a-10d, 20a-20d) is adapted to emit and receive electric currents as well as make electric potential difference measurements across measurement electrode pairs on their respective surfaces. This measurement technique is not to be confused with conventional tools that measure micro-resistivity (MR) in water-based mud systems, which typically emit AC currents from the tool mass via the mud system, the conductive mud cake, and the formation to MR sensors on the pads (and vice-versa) and require electrical isolation of the tool mass from the MR sensors on the tool pads to perform the measurements. Such multi-tool systems for water-based mud use therefore require that the tools be electrically isolated from one another to be able to obtain a measurement, otherwise the current from one tool will flow along the tool body to the next tool(s). The micro-voltage measurement provided by the present invention is obtained independently be each upper and lower tool, so the adapter 50 can provide rotational offset as well as electrical and mechanical connectivity/conductivity between the upper and lower tools, without the need for electrical isolation.

In cases where multiple micro-resistivity measurement tools designed for water-based muds are used, the current loop in the formation created by one tool (e.g. upper tool) may interfere with the current because the current is emitted by the tool body which is some distance away from the pads where it is received, producing a fairly large current loop. This type of measurement is not feasible in OBMs and SOBMs due to the highly resistive mud cake created on the wellbore surface.

By judicial placement of the emitter, receiver, and electrodes on the pad, embodiments of the invention can overcome this high resistivity. By placing measurement electrodes close to one another, the current loop is kept relatively small. This allows the addition of other tools above and/or below the first (longitudinally offset) such that the additional tool(s) can make its own set of measurements by creating its own ‘little’ current loop with no, or infinitesimally minimal, interference from the current loop created by the first tool.

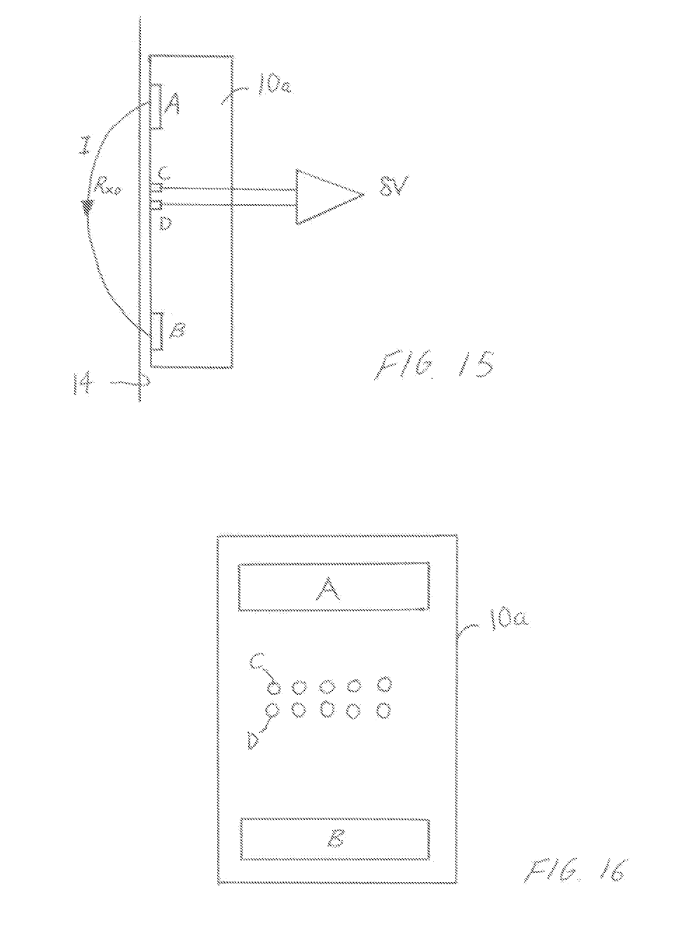

Turning to FIG. 15, a schematic of a pad implementation of the invention is shown to illustrate a subsurface measurement obtained with the disclosed system. In operation, the tool pads (10a-10d, 20a-20d) are applied against the wellbore wall 14. Typically, a layer of nonconductive mud will reside between the pad surface and the formation. An AC current is injected into the formation between electrodes A and B on the pad 10a. The AC current is emitted from either electrode A, B to travel through the mud cake into the formation, out from the formation through the mud cake into the other electrode, and when the cycle is reversed the current path is also reversed. A pair of electrodes C, D on the pad 10a are used to measure the potential difference δV in the formation facing the electrodes. From these electromagnetic parameter measurements, properties of the borehole/formation can be determined (e.g. the resistivity of the invaded zone Rₓₒ) using known inversion techniques. FIG. 16 shows a pad 10a embodiment of the invention having five pairs of voltage electrodes C, D on the pad surface. Each pad on the respective tool 40a, 40b acquires multiple measurements, and the data can be displayed on a color image, oriented with respect to the geometry of the tool and borehole. It will be appreciated by those skilled in the art that embodiments of the invention can be implemented with any number of pads 10a may be disposed on each tool as desired.

The invention being thus described, it will be obvious that the same may be varied in many ways. It will be appreciated by those skilled in the art that any suitable components, electronics, and processor software may be used to implement embodiments of the invention as known in the art. It will also be appreciated that while the disclosed system is described for conveyance into a wellbore on a cable or wireline, it is not to be limited to such implementations as the system may also be deployed on a slickline, coiled tubing, extending from a drill collar, etc. (not shown). Such variations are not be regarded as a departure from the scope of the invention, and all such modifications as would be obvious to one skilled in the art are intended to be included within the scope of the following claims.

What is claimed is:

1. A system for subsurface measurements in a wellbore, comprising:
a first tool including a first plurality of pads to be positioned against a surface of the wellbore, each of the pads having a first plurality of electrodes disposed thereon to emit electric current between said electrodes and a second plurality of electrodes disposed thereon between the first plurality of electrodes to measure an electromagnetic parameter;
a second tool including a second plurality of pads to be positioned against a surface of the wellbore, each of the pads having a first plurality of electrodes disposed thereon to emit electric current between the first plurality of electrodes to measure an electromagnetic parameter;
the second tool being longitudinally offset from the first tool; and
the second plurality of pads of the second tool being rotationally offset relative to the first plurality of pads of the first tool.

2. The system of claim 1, wherein the first plurality of pads of the first tool include a first pad, a second pad spaced angularly from the first pad, a third pad spaced angularly from the second pad, and a fourth pad spaced angularly from the third pad.

3. The system of claim 2, wherein the second plurality of pads of the second tool include a first pad, a second pad placed angularly from the first pad, a third pad spaced angularly from the second pad, and a fourth pad spaced angularly from the third pad.

4. The system of claim 3, wherein the first pad of the second tool is rotational offset from the first pad of the first tool by a predetermined angle, the first pad of the second tool being longitudinally offset from the first pad of the first tool.

5. The system of claim 4, wherein the second pad of the second tool is rotationally offset from the second pad of the first tool by the predetermined angle, the second pad of the second tool being longitudinally offset from the second pad of the first tool.

6. The system of claim 5, wherein the third pad of the second tool is rotationally offset from the third pad of the first tool by the predetermined angle, the third pad of the second tool being longitudinally offset from the third pad of the first tool.

7. The system of claim 6, wherein the fourth pad of the second tool is rotationally offset from the fourth pad of the first tool by the predetermined angle, the fourth pad of the second tool being longitudinally offset from the fourth pad of the first tool.

8. The system of claim 1, wherein the first and second tools are disposed in the wellbore on a wireline.

9. The system of claim 1, further comprising an adapter positioned between the first and second tools to offset the tools rotationally with respect to one another.

10. A method for making a subsurface measurement in a wellbore comprising
a) disposing a tool within a wellbore traversing a subsurface formation, the tool including:
a first tool including a first plurality of pads to be positioned against a surface of the wellbore, each of the pads having a first plurality of electrodes disposed thereon to emit electric current between said electrodes and a second plurality of electrodes disposed thereon between the first plurality of electrodes to measure an electromagnetic parameter;
a second tool including a second plurality of pads to be positioned against a surface of the wellbore, each of the pads having a first plurality of electrodes disposed thereon to emit electric current between said electrodes and a second plurality of electrodes disposed thereon between the first plurality of electrodes to measure an electromagnetic parameter, the second tool being longitudinally offset from the first tool and the second plurality of pads of the second tool being rotationally offset relative to the first plurality of pads of the first tool;
b) emitting current between the first plurality of electrodes on at least one pad on the first tool and between the first plurality of electrodes on at least one pad on the second tool when each at least one pad is positioned against a surface of the wellbore; and
c) measuring an electromagnetic parameter with the second plurality of electrodes on the at least one pad on the first tool and with the second plurality of electrodes on the at least one pad on the second tool.

11. The method of claim 10, wherein the tool is disposed in a wellbore containing a nonconductive fluid.

12. The method of claim 10, wherein the tool is disposed in a wellbore containing an oil-base or synthetic-base fluid.

13. The method of claim 10, wherein the first plurality of pads of the first tool include a first pad, a second pad spaced angularly from the first pad, a third pad spaced angularly from the second pad, and a fourth pad spaced angularly from the third pad.

14. The method of claim 13, wherein the second plurality of pads of the second tool include a first pad, a second pad spaced angularly from the first pad, a third pad spaced angularly from the second pad, and a fourth pad spaced angularly from the third pad.

15. The method of claim 14, wherein the first pad of the second tool is rotationally offset from the first pad of the first tool by a predetermined angle, the first pad of the second tool being longitudinally offset from the first pad of the first tool.

16. The method of claim 15, wherein the second pad of the second tool is rotationally offset from the second pad of the first tool by the predetermined angle, the second pad of the second tool being longitudinally offset from the second pad of the first tool.

17. The method of claim 16, wherein the third pad of the second tool is rotationally offset from the third pad of the first tool by the predetermined angle, the third pad of the second tool being longitudinally offset from the third pad of the first tool.

18. The method of claim 17, wherein the fourth pad of the second tool is rotationally offset from the fourth pad of the first tool by the predetermined angle, the fourth pad of the second tool being longitudinally offset from the fourth pad of the first tool.

19. The method of claim 10, wherein step (a) comprised disposing the tool in the wellbore on a wireline.

20. The method of claim 10, further comprising determining a resistivity value for the formation using the measured electromagnetic potential difference.
